(19) United States
(12) Patent Application Publication
(10) Pub. No.: US 2017/0193409 A1
(43) Pub. Date: Jul. 6, 2017

(54) BUSINESS RESOURCE MODELING

(71) Applicant: HEWLETT PACKARD ENTERPRISE DEVELOPMENT LP, Houston, TX (US)

(72) Inventors: David M. STEVENS, Bristol (GB); Christopher ROGERS, Telford (GB); David R. KNIGHT, Kendal (GB); Sean W. O'BRIEN, Thurleigh (GB)

(73) Assignee: HEWLETT PACKARD ENTERPRISE DEVELOPMENT LP, Houston, TX (US)

(21) Appl. No.: 15/306,730

(22) PCT Filed: Sep. 19, 2014
(86) PCT No.: PCT/US2014/056682

§ 371 Date: Oct. 25, 2016

(51) Int. Cl. G06Q 10/06; G06F 17/30

(52) U.S. Cl. CPC G06Q 10/067; G06F 17/30864

(57) ABSTRACT

A computer implemented method includes receiving indexing data for groupings of business resources, identifying a first grouping of business resources from the groupings of business resources in response to a user query based on the indexing data, and retrieving a first business resource model associated with the first grouping of business resources. The first business resource model defines relationships among the business resources in the first grouping and further defines relationships among the groupings of business resources with respect to the first grouping of business resources. The method also includes generating a second business resource model based on the first business resource model in response to user input, and providing access to a second grouping of business resources associated with the second business resource model.

### BACKGROUND

Information technology and business units that provide managed services frequently refactor and reuse bundled business resources depending on the needs of clients at a given point in time. Providers of managed services may trace reference architectures for business resource offerings among multiple client-specific implementations.

### BRIEF DESCRIPTION OF THE DRAWINGS

FIG. 1 is a schematic illustration of an example business resource modeling system.

FIG. 2 is a flow diagram of an example method that may be carried out by the business resource modeling system of FIG. 1.

FIG. 3 is a diagram of an example format for providing indexing data for a grouping of business resources.

FIG. 4 is a diagram of another example format for providing indexing data for a grouping of business resources.

FIG. 5 is a diagram of another example format for providing indexing data for a grouping of business resources.

FIG. 6 is a diagram of an example graphical user interface for identifying a grouping of business resources in response to a user query based on indexing data.

FIG. 7 is a diagram of an example graphical user interface for defining relationships among groupings of business resources.

FIG. 8 is a diagram of an example graphical user interface for generating and modifying business resource models.

FIG. 9 is a diagram of an example architecture reference model for supporting business resource modeling.

FIG. 10 is a diagram of a detailed example of the architecture reference model for supporting business resource modeling shown in FIG. 9.

FIG. 11 is a diagram of another detailed example of the architecture reference model for supporting business resource modeling shown in FIG. 9.

FIG. 12 is a diagram of the example of the architecture reference model for supporting business resource modeling shown in FIG. 9 showing business layer, application layer, and technology layer overlays.

FIG. 13 is a flow diagram of another example method that may be carried out by the business resource modeling system of FIG. 1.

### DETAILED DESCRIPTION OF EXAMPLES

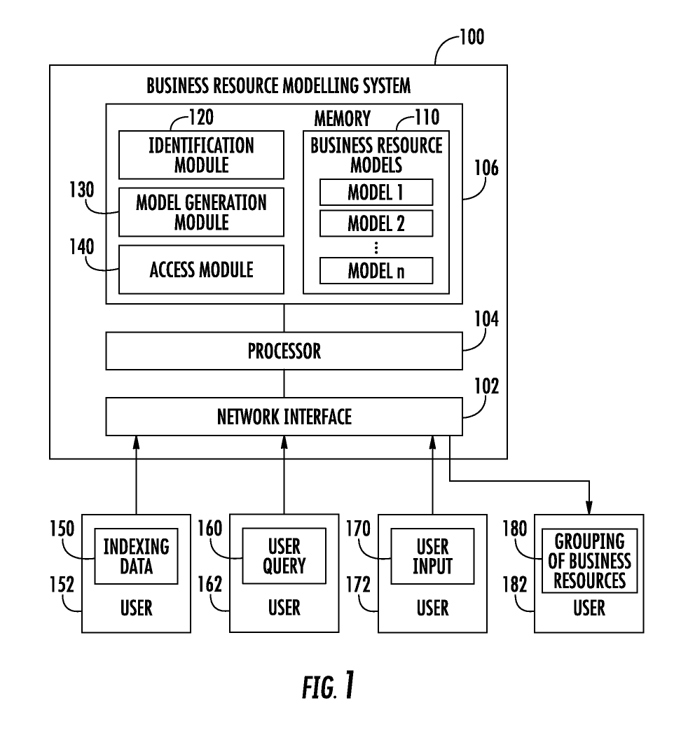

FIG. 1 schematically illustrates an example business resource modeling system 100. As will be described hereafter, business resource modeling system 100 allows users, such as providers of managed services, to maintain traceability among reference architectures for business resource offerings among multiple client-specific implementations. Business resource modeling system 100 also allows users to identify, manage, and reuse existing reference architectures for bundled business resources.

Business resource modeling system 100 includes a computing device or system, such as a server or system of servers that allows users to maintain traceability among reference architectures for business resource offerings among multiple client-specific implementations, and to identify, manage, and reuse existing reference architectures for bundled business resources. Business resource modeling system 100 includes network interface 102, one or more processors 104, and a memory 106. Network interface 102 includes an electronic or optical interface by which business resource modeling system 100 communicates to other computing devices or sources of data through a local area network and/or a wide-area network, such as the Internet.

One or more processors 104 include one or more processing units configured to carry out instructions contained in memory 106. In general, following instructions contained in memory 106, the one or more processors 104 allows users to maintain traceability among reference architectures for business resource offerings among multiple client-specific implementations, and to identify, manage, and reuse existing reference architectures for bundled business resources. For purposes of this application, the term “processing unit” shall mean a presently developed or future developed processing unit that executes sequences of instructions contained in a memory. Execution of the sequences of instructions causes the one or more processing units to perform steps such as generating control signals. The instructions may be loaded in a random access memory (RAM) for execution by the one or more processing units from a read only memory (ROM), a mass storage device, or some other persistent storage. In other embodiments, hardwired circuitry may be used in place of or in combination with software instructions to implement the functions described. For example, the functionality of business resource modeling system 100 may be implemented entirely or in part by one or more application-specific integrated circuits (ASICs). Unless otherwise specifically noted, business resource modeling system 100 is not limited to any specific combination of hardware circuitry and software, nor to any particular source for the instructions executed by the one or more processing units.

Memory 106 includes a non-transient computer-readable medium or other persistent storage device, volatile memory such as DRAM, or some combination of these; for example a hard disk combined with RAM. Memory 106 contains instructions for directing the carrying out of functions and analysis by one or more processors 104. In some implementations, memory 106 further stores data for use by the one or more processors 104. Memory 106 stores various software or code modules that direct processor 104 to carry out various interrelated actions. In the example illustrated, memory 106 includes business resource models 110. Business resource models 110 include reference architectures for groupings of business resources. By way of example, a grouping of business resources may be an end-to-end grouping of resources included in a product or service offering, or other business solution provided by a managed services provider to a client. A grouping of business resources may also be a single business resource or subgroup of business resources included in a product or service offering, or other business solution that may either stand alone or function as a shared resource that may be combined with other business resources to comprise another product or service offering.

Business resources include, for example, objects such as software resources, physical resources, and human resources. Software resources include, for example, email services, invoicing services, credit card processing services, collaboration services, analytics, Infrastructure as a Service (IaaS) resources, Platform as a Service (PaaS), Software as a Service (SaaS), databases, access and security management services, fault management services, etc. Physical and human resources include, for example, servers, help desk services, regional and global language support services, etc. As such, an example grouping of business resources may include a credit card payment processing service, another example grouping of business resources may include a help desk with language support, while yet another example grouping of business resources combines the credit card payment processing service with the help desk with language support.

As set forth above, business resource models 110 include reference architectures for groupings of business resources. Business resource models 110 may be based upon, for example, Archimate and/or Topology and Orchestration Specification for Cloud Applications (TOSCA) standards. As will be described hereafter, business resource models 110 define relationships among business resources in groupings of business resources and maintain traceability among reference architectures for groupings of business resource offerings among, for example, multiple client-specific implementations.

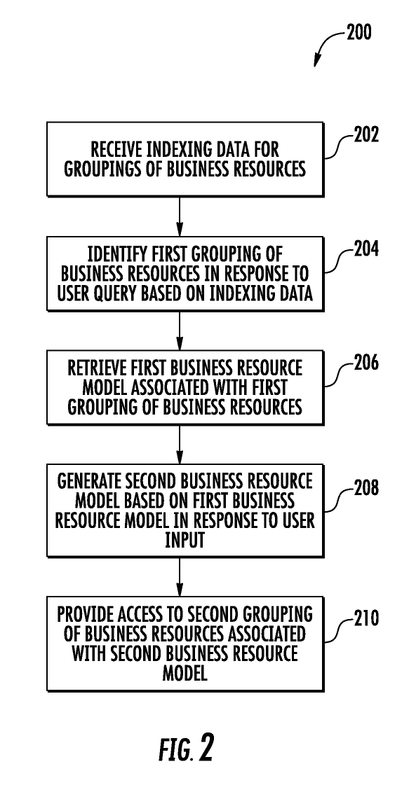

In the example illustrated, memory 106 also includes identification module 120, model generation module 130, and access module 140. Modules 120, 130, and 140 cooperate to direct processor 104 to carry out the method 200 set forth by the flow diagram of FIG. 2. As indicated by a step 202, identification module 120 receives indexing data 150 for groupings of business resources. Indexing data 150 may include, for example, data that may be mapped to objects that are, in turn, mapped to business resource models 110. For example, business resource modeling system 100 may utilize enterprise architecture management software, such as Enterprise Maps software provided by Hewlett-Packard Company, in order to manage business resource models 110. Indexing data 150 may include data mapped to objects in the enterprise architecture management software so that users may identify, manage, and reuse existing business resource models 110.

By way of example, indexing data 150 may include data mapped to “Product,” “Representation,” “Value,” “Business Actors,” “Business Function,” “Business Events,” “Business Services,” “Business Role,” “Business Collaboration,” “Business Interface,” and/or other objects at the business layer in Enterprise Maps enterprise architecture management software. Similarly, keywords such as “Value Proposition,” “Key Partners,” “Key Activities,” “Customer Relationships,” “Customer Segments,” “Customer Jobs,” “Cost Structure,” “Revenue Stream,” “Gain,” “Gain Creators,” “Pain Relievers,” and/or other keywords may be used at the business layer in Enterprise Maps enterprise architecture management software to facilitate identification, management, and reuse of existing business resource models 110. Other mapping objects, fields, and keywords are contemplated as well.

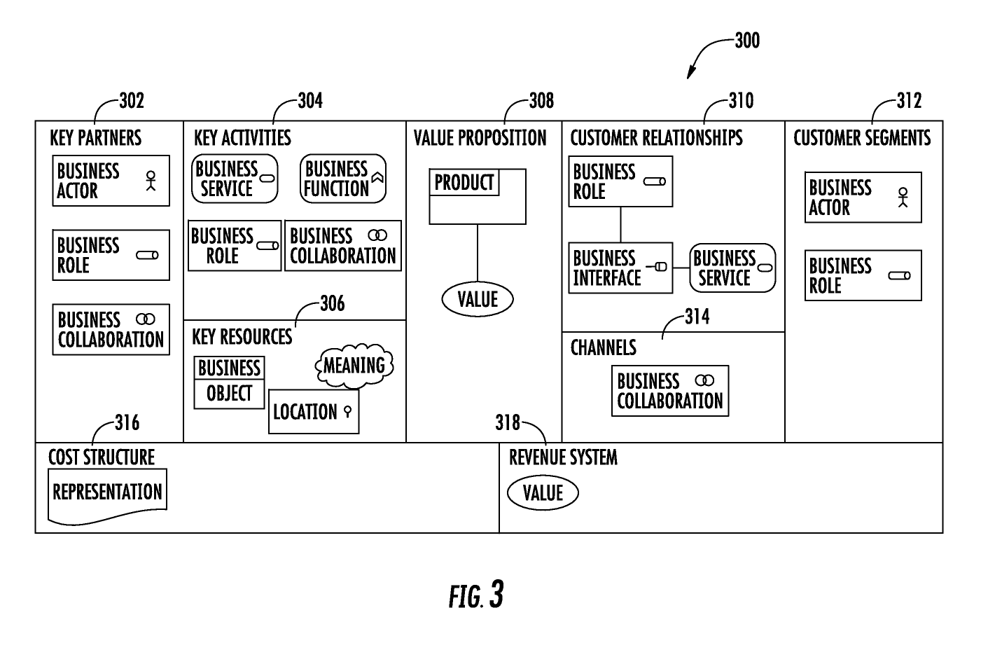

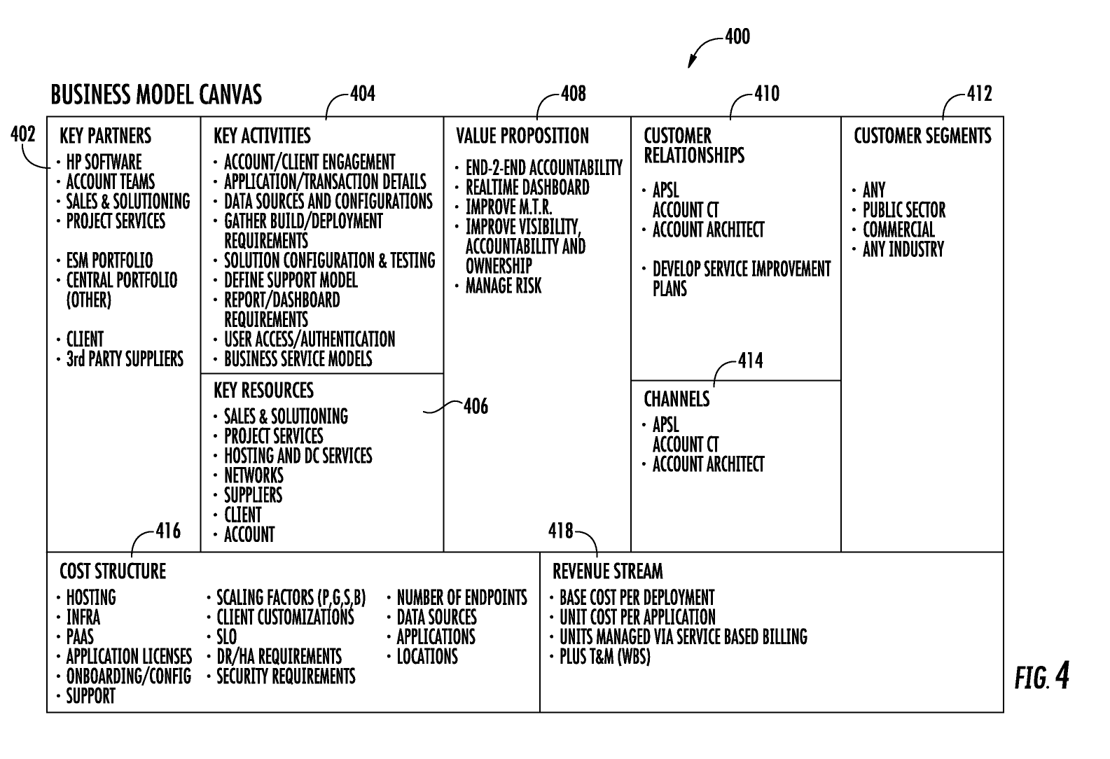

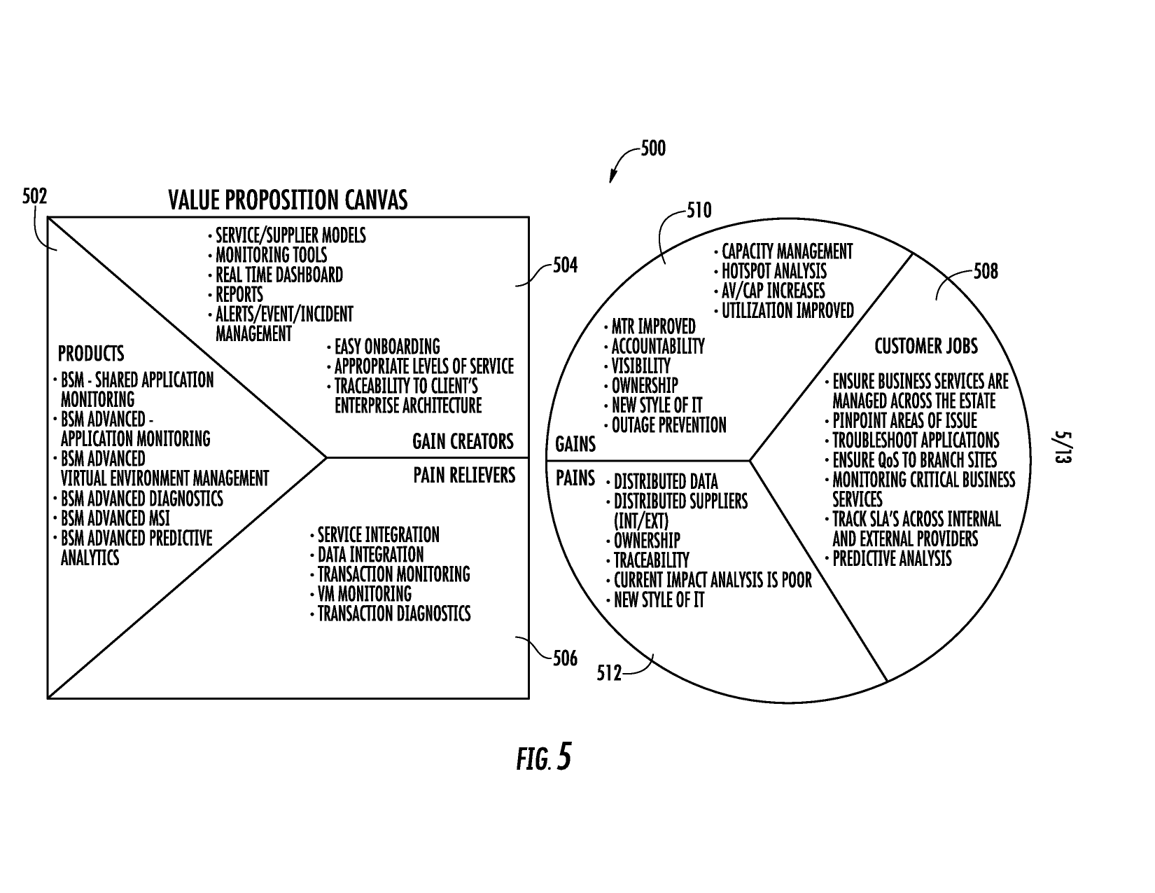

Indexing data 150 may be provided by, for example, users 152 associated with a provider of managed services, such as a client principal or a system architect. Indexing data 150 may also be provided by, for example, a third party user such as a business partner or independent software vendor. Indexing data 150 may be provided at, for example, the proposal stage for a new grouping of business resources, during management of an existing grouping of business resources, during modification or reuse, etc. Indexing data 150 may be gathered by, for example, use of a business canvas form that may be populated by a user 152 of business resource modelling system 100. For example, FIGS. 3-5 illustrate diagrams of example formats for providing indexing data 150 for a grouping of business resources. FIG. 3 illustrates a format 300 in which indexing data 150 may be organized in categories including Key Partners data 302, Key Activities data 304, Key Resources data 306, Value Proposition data 308, Customer Relationships data 310, Customer Segments data 312, Channels data 314, Cost Structure data 316, and Revenue Stream data 318. FIG. 4 illustrates a format 400 similar to the format shown in FIG. 3, but with examples of Key Partners data 402, Key Activities data 404, Key Resources data 406, Value Proposition data 408, Customer Relationships data 410, Customer Segments data 412, Channels data 414, Cost Structure data 416, and Revenue Stream data 418. FIG. 5 illustrates a format 500 in which a Value Proposition Canvas is implemented. Format 500 includes Products data 502, Gain Creators data 504, Pain Relievers data 506, Customer Jobs data 508, Gains data 510, and Pains data 512.

Referring again to FIG. 2, as indicated by a step 204, identification module 120 also identifies groupings of business resources in response to, for example a user query 160 from a user 162. User query 160 may be, for example, a keyword search facilitated by enterprise architecture management software that allows user 162 to identify relevant groupings of business resources based on indexing data 150 mapped to business resource models 110 associated with the groupings of business resources.

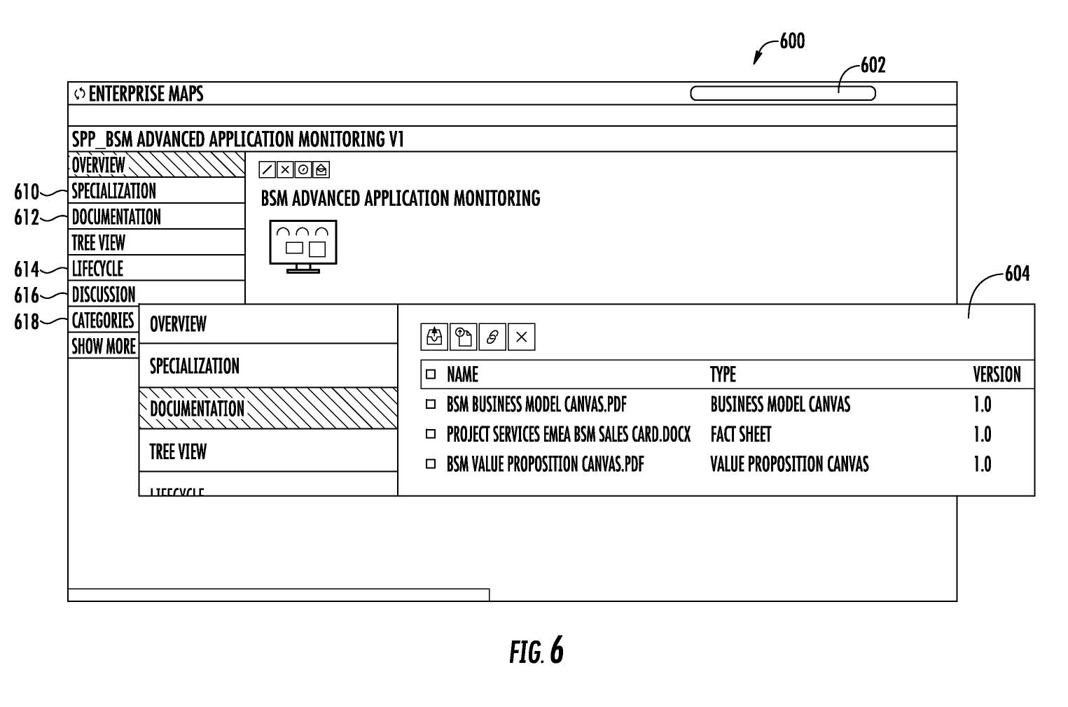

For example, FIG. 6 is a diagram of an example graphical user interface 600 for identifying a grouping of business resources in response to a user query based on indexing data. A user may enter keywords in a field 602 and receive a list 604 of identified relevant groupings of business resources. Graphical user interface 600 also allows a user to retrieve detailed information about a particular grouping of business resources in list 604. For example, graphical user interface 600 may provide a link 610 to specialization data indicating whether and where a particular grouping of business resources is currently deployed. Graphical user interface 600 also provides a link 612 to supporting documentation associated with a particular grouping of business resources. Graphical user interface 600 also provides a link 614 to lifecycle data (e.g., data conforming to Topology and Orchestration Specification for Cloud Applications (TOSCA) standards indicating the current lifecycle stage (e.g., development, ready for deployment, retired, etc.). Graphical user interface 600 also provides a link 616 to discussion data that may include comments or collaboration data regarding a particular group of business resources. Graphical user interface 600 also provides a link 618 to categories data regarding search tags associated with a particular grouping of business resources.

Referring again to FIG. 2, user 162 may be, for example, a client principal or a system architect associated with a provider of managed services. User 162 may also be, for example, a client or third party user such as a business partner or independent software vendor. By way of example, user 162 may be a client principal employed by a managed services provider and may receive a request from a client for a business solution that leverages social media resources. User 162 may review the request and determine keywords that may be used to identify any existing groupings of business resources that may be leveraged, modified or otherwise reused to provide a solution for the client. For example, the client may specify or otherwise indicate that “brand loyalty,” “social media,” “real-time” and “decision making” are to be key aspects of the business solution. User 162 may a conduct a keyword search facilitated by enterprise architecture management software for the terms “brand loyalty,” “social media,” “real-time” and “decision making. The keyword search may allow user 162 to identify relevant groupings of business resources based on indexing data 150 mapped to business resource models 110 associated with the groupings of business resources. For example, the keyword search may identify three different groupings of business resources having business resource models 110 stored in business resource modeling system 100 that may potentially be reused. User 162 may review supporting documentation associated with these groupings of business resources and check to see whether and where each grouping is currently deployed. User 162 may then select, for example, a generic social media solution that provides analysis that may be used to increase brand loyalty. User 162 may then notify the client that the identified social media solution may be of interest to the client, and may be modified to tailor it to the client's specific needs.

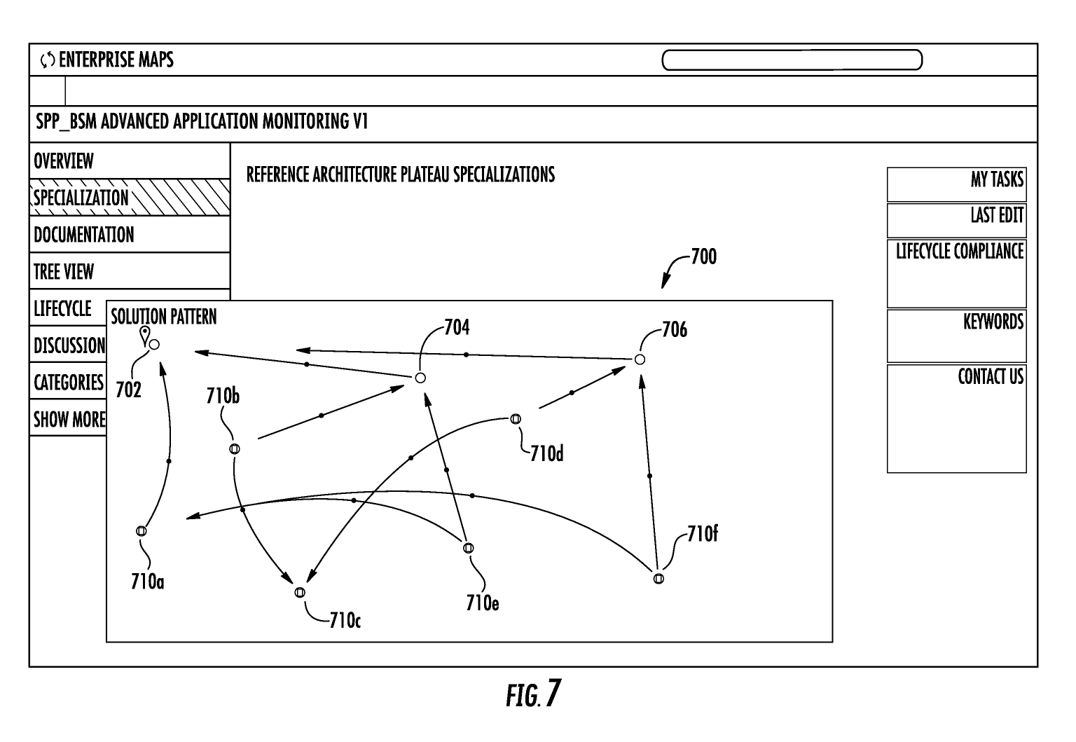

As indicated by a step 206, model generation module 130 retrieves a business resource model 110 associated with an identified grouping of business resources. Business resource models 110 may be based upon, for example, Archimate and/or TOSCA standards. Business resource model 110 may define relationships among business resources in groupings of business resources and maintain traceability among reference architectures for groupings of business resource offerings among, for example, multiple client-specific implementations. For example, a business resource model 110 may reflect that a grouping of business resources includes invoicing services, email and a help desk with language support. The business resource model 110 may further reflect that the grouping of business resources is leveraged by two different business solutions for two different clients: an implementation with French language support and an implementation with German language support. By way of another example, FIG. 7 is a diagram of an example graphical user interface 700 for defining relationships among groupings of business resources. Graphical user interface 700 indicates that a grouping of business resources entitled “BSM Advanced Application Monitoring” 702 is utilized in two different client plateaus 704 and 706, and six related products 710a-710f.

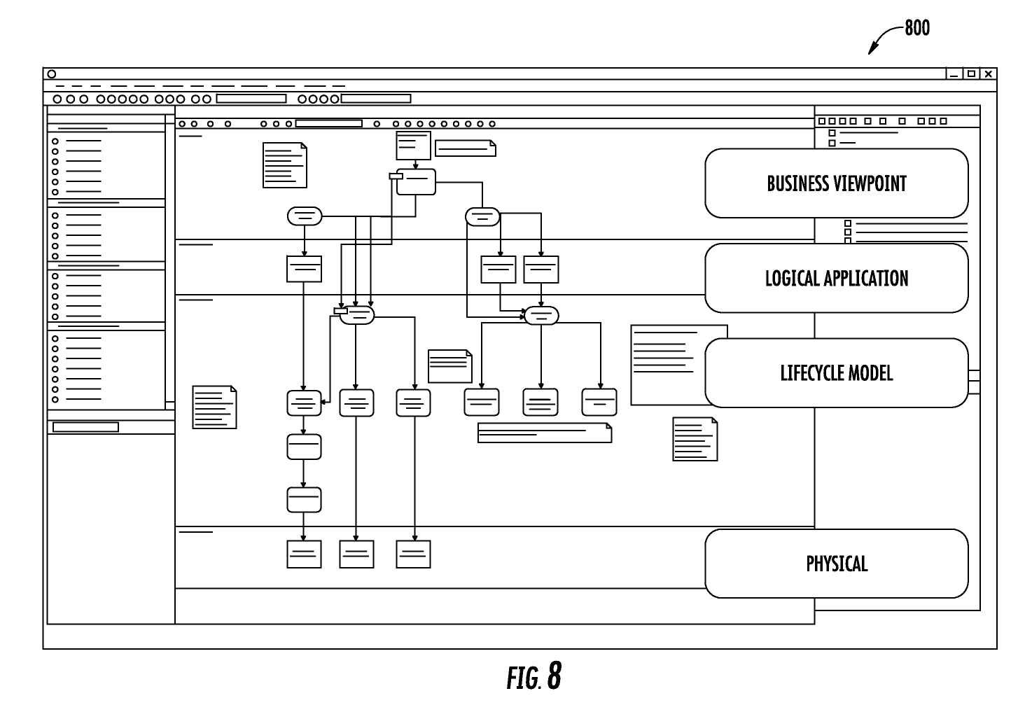

Referring again to FIG. 2, business resource model 110 may also reflect technical details of a grouping of business resources, such as relationships among objects such as business level components, service components, local applications, deployment models, installation instructions, foundation service, lifecycle models, physical components etc. For example, technical details of business resource model 110 may be viewed and modified using an architecture modeling and design tool, such as Enterprise Architect software provided by Sparx Systems. By way of example, FIG. 8 is a diagram of an example graphical user interface 800 for generating and modifying business resource models in an architecture modeling and design tool using business resource models compliant with Archimate and TOSCA standards.

Referring again to FIG. 2, as indicated by a step 208, model generation module 130 generates new business resource models 110 from existing business resource models 110 in response to user input 170 from a user 172. User input 170 may be, for example, input provided via an architecture modeling and design tool such as Enterprise Architect provided by Sparx Systems. User input 170 may request model generation module 130 to copy a business resource model 110, and/or to modify the business resource model 110, such as by adding or removing components. User 172 may be, for example a system architect associated with a provider of managed services.

By way of example, user 172 may be a system architect who has received a request from a client principal to create a new business resource model 110 for a new grouping of business resources. The new grouping of business resources may be, for example, a social media solution that provides analysis that may be used to increase brand loyalty. The client principal may have further indicated that the client is interested in leveraging an existing grouping of business resources comprising a generic social medial solution and modifying it in order to tailor it to the client's specific needs. As such, user 172 may access business resource modeling system 100 and request model generation module 130 to make a copy of an existing business resource model 110 associated with the grouping of business resources comprising the existing generic social media solution. Model generation module 130 may then duplicate objects included in the existing business resource model 110 and use them as new objects in a new business resource model 110 to be associated with the new grouping of business resources for the client. Model generation module 130 maintains full traceability of the objects in the new business resource model 110 back to the original objects in the existing business resource model 110. The objects include relationships and attributes needed to deploy, manage, and modify the new grouping of business resources.

User 172 may then provide user input 170 requesting model generation module 130 to modify the new business resource model 110 in order to tailor it to the client's specific needs. For example, model generation module 130 may provide access to an architecture modeling and design tool that facilitates review and modification of the new business resource model 110 via graphical user interfaces. User 172 may import the new business resource model 110 into the architecture modeling and design tool and make any changes necessary to objects in the new business resource model 110, such as adding, changing, or deleting business layer objects, application layer objects, technical layer objects, etc. in order to meet the client's requirements. The new business resource model 110 includes any required objects from the original business resource model 110 as well as any new objects, such as services, components, lifecycle models, etc., needed in order to meet the client's requirements. In particular, the new business resource model 110 represents efficient use of an existing business resource model 110 to create a new social media solution that provides analysis that may be used to increase brand loyalty. User 170 may then request model generation module 130 to save the new business resource model 110 in memory 106. Model generation module may further provide for governance of model generation module 130, such as review, comment, approval, and release.

In another example, user 172 may be a system architect who has received a request from a client principal to create a new business resource model 110 for a new grouping of business resources. The new grouping of business resources may be, for example, a version of the social media solution described above that may be used with a different social media application used in China. The client principal may have further identified an existing social medial integration application for China using identification module 120. As such, user 172 may access business resource modeling system 100 and request model generation module 130 to make a copies of the existing business resource model 110 for the client's social media solution, as well as the existing business resource model 110 for the social medial integration application for China. Model generation module 130 may then duplicate objects included in each of the existing business resource models 110 and use them as new objects in a new business resource model 110 to be associated with the new grouping of business resources for the client. Model generation module 130 maintains full traceability of the objects in the new business resource model 110 back to the original objects in the existing business resource models 110. The objects include relationships and attributes needed to deploy, manage, and modify the new grouping of business resources.

User 172 may then provide user input 170 requesting model generation module 130 to modify the new business resource model 110 in order to tailor it to the client's specific needs. For example, model generation module 130 may provide access to an architecture modeling and design tool that facilitates review and modification of the new business resource model 110 via graphical user interfaces. User 172 may import the new business resource model 110 into the architecture modeling and design tool and make any changes necessary to objects in the new business resource model 110, such as adding, changing, or deleting business layer objects, application layer objects, technical layer objects, etc. in order to meet the client's requirements. The new business resource model 110 includes any required objects from the original business resource models 110 as well as any new objects, such as services, components, lifecycle models, etc., needed in order to meet the client's requirements. In particular, the new business resource model 110 represents efficient reuse of two existing business resource models 110 to create a new version of the client's social media solution that may be used in China. User 170 may then request model generation module 130 to save the new business resource model 110 in memory 106. Model generation module may further provide for governance of model generation module 130, such as review, comment, approval, and release.

As indicated by a step 210, access module 140 provides access to groupings of business resources 180 associated with business resource models 110 for a user 182. User 182 may be, for example, a client that has requested a particular business solution from a managed services provider. Access module 140 may utilize, for example, service marketplace software such as CSA4 Marketplace software provided by Hewlett-Packard Company. Access module 140 may allow user 182 to browse and order existing groupings of business resources 180 packaged as business solutions from a central marketplace. Access module 140 may also allow groupings of business resources 180 packaged as business solutions be automatically deployed from the central marketplace. Access module 140 may further allow be deployed to public and/or managed cloud systems.

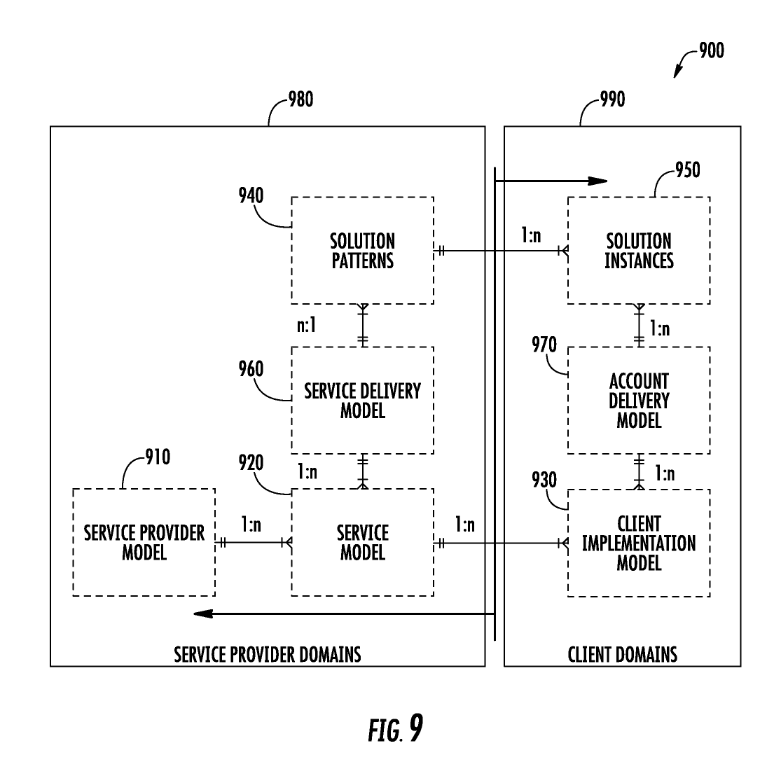

FIG. 9 is a diagram of an example architecture reference model 900 for supporting business resource modeling. Architecture reference model 900 may allow users, such as managed services providers, to implement end-to-end traceability for business resource models across the entire model, to analyze the impact of changes to object within a business resource model, and to leverage business resource models from multiple varying business solutions against a standard architecture reference model. As illustrated in FIG. 9, architecture reference model 900 includes a service provider model 910. Service provider model 910 may include, for example, centralized functions, such as invoicing, billing, finance, central strategy, and portfolios. Each service provider model 910 may have a 1:n relationship with corresponding service models 920. Service models 920 may represent details of groupings of business resources included in a product or service offering, or other business solution offering that may be managed by a particular offering team. Each service model 920 may have a 1:n relationship with corresponding client implementation models 930. Client implementation models 930 may represent particular client implementations of a corresponding service model 920. Each client implementation model 930 may include relationships to a corresponding service provider model 910, as well as any variants required for the client implementation.

Architecture reference model 900 also includes solution patterns 940 and solution instances 950. Solution patterns 940 and solution instances 950 may allow for the grouping of multiple product or service offerings, or other business solution offerings into a combined offering. Solution patterns 940 have an n:1 relationship with a corresponding service delivery model 960, and solution instances 950 have an n:1 relationship with a corresponding account delivery model 970. In turn, service delivery models 960 have an n:1 relationship with each corresponding service model 920, and account delivery models 970 have an n:1 relationship with each corresponding client implementation model 930. Separating each service delivery model 960 from its corresponding service model 920, and each account delivery model 970 from its corresponding client implementation model 930 may allow a delivery or support organization may support multiple offerings. As illustrated in FIG. 9, service provider models 910, service models 920, service delivery models 960, and solution patterns 940 are included in a service provider domain 980. Client implementation models 930, account delivery models 970, and solution instances 950 are included in a client domain 990.

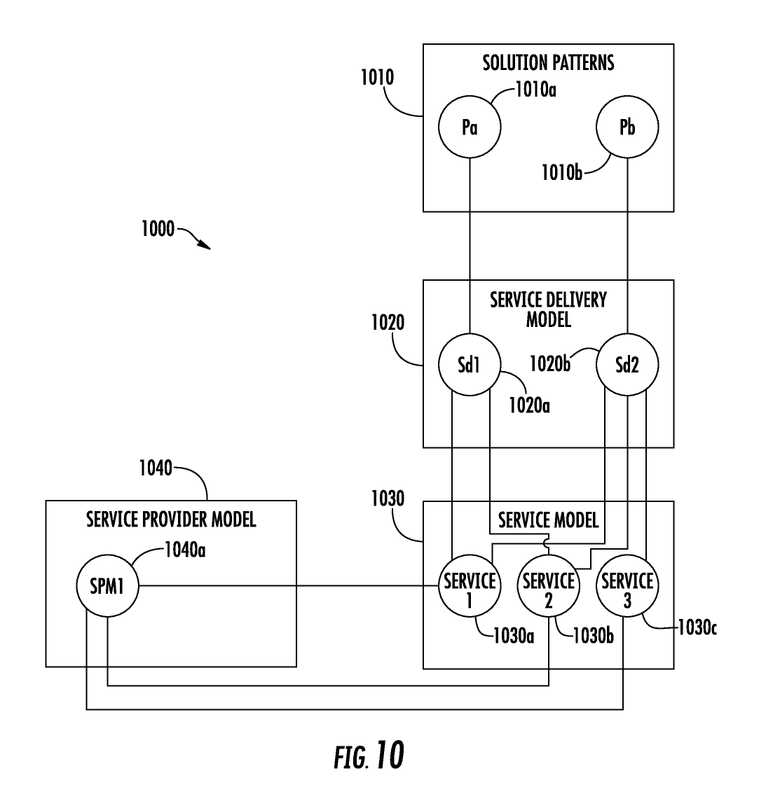

FIG. 10 is a diagram of a detailed example of the architecture reference model for supporting business resource modeling shown in FIG. 9. In particular, FIG. 10 illustrates a service provider domain 1000 that may be used to represent and manage groupings of business resources packaged as two different business solution offerings. Service provider domain 1000 includes solution patterns 1010, service delivery model 1020, service model 1030, and service provider model 1040. Solution patterns 1010 include solution patterns 1010a and 1010b. Service delivery model includes service delivery organizations 1020a and 1020b. Service model 1030 includes service models 1030a, 1030b, and 1030c. Service provider model 1040 includes a shared function 1040a.

Solution patterns 1010a and 1010b each represent variant groupings of business resources packaged as two different business solution offerings. Solution pattern 1010a is supported by service delivery organization 1020a, which may be a European Union (EU) support organization, and solution pattern 1010b is supported by service delivery organization 1020b, which may be a global support organization. Service organization 1020a provides service 1030a, which may be, for example, a concurrent version system (CVS) service, and service 1030b, which may be, for example, an email service, as a bundled offering. Service organization 1020b similarly bundles services 1030a and 1030b, and adds an additional service 1030c, which may be, for example, a thin client service. Service 1030a also leverages a shared function 1040a, which may be, for example, a billing service, such that solution patterns 1010a and 1010b each include this function. Accordingly, service provider domain 1000 facilitates representation and management of both an EU support offering that bundles shared CVS, email, and billing services that are leveraged at different levels, as well as a global support offering that includes these services and adds thin client service to its offering.

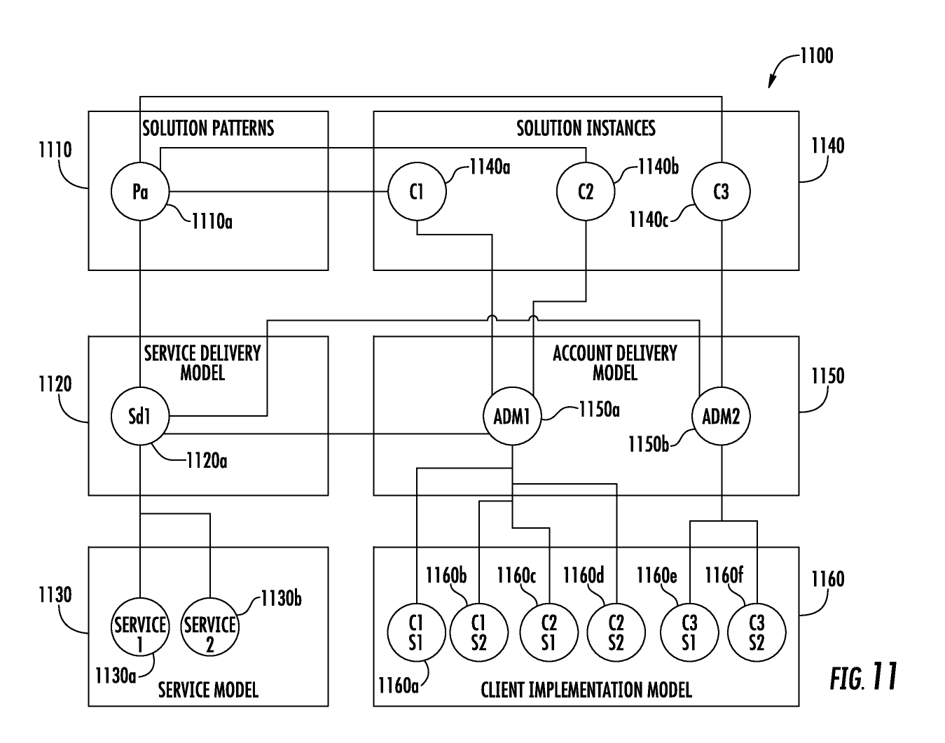

FIG. 11 is a diagram of another detailed example of the architecture reference model for supporting business resource modeling shown in FIG. 9. In particular, FIG. 11 illustrates an example architecture reference model 1100 in which a solution pattern is represented against multiple client implementations. Architecture reference model 1100 includes solution patterns 1110, service delivery model 1120, service model 1130, solution instances 1240, account delivery model 1250, and client implementation model 1160. Solution patterns 1110 include solution pattern 1110a, which is supported by a service delivery organization 1120a included in service delivery model 1120. Service delivery organization 1120a provides service 1130a, which may be, for example, an email service, and service 1130b, which may be, for example, a thin client service, as a bundled offering. Services 1130a and 1130b are included in service model 1130.

Solution instances 1140 include a client implementation 1140a, a client implementation 1140b, and a client implementation 1140c, each of which corresponds to solution pattern 1110a. Client implementation 1140a may correspond to, for example, a Client A, while client implementations 1140b and 1140c may correspond respectively to Client B and Client C. Account delivery model 1150 includes two different client delivery organizations 1150a and 1150b, which may be, for example, UK support and EU support organizations respectively. Client delivery organizations 1150a and 1150b are client-specific variations of service delivery organization 1120a. Client delivery organization 1150a may provide UK support for client implementations 1140a and 1140b, while client delivery organization 1150b may provide EU support for client implementation 1140c. Client implementation model 1160 includes services 1160a and 1160b, which are implementations of bundled services 1130a and 1130b for Client A. Similarly, client implementation model 1160 includes services 1160c and 1160d, which are implementations of bundled services 1130a and 1130b for Client B, and also includes services 1160e and 1160f, which are implementations of bundled services 1130a and 1130b for Client C. Accordingly, architecture reference model 1100 facilitates representation and management of implementations of email and thin client services for Clients A, B, and C, wherein Client A and Client B are supported by a client UK support organization, and Client C is supported by a client EU support organization.

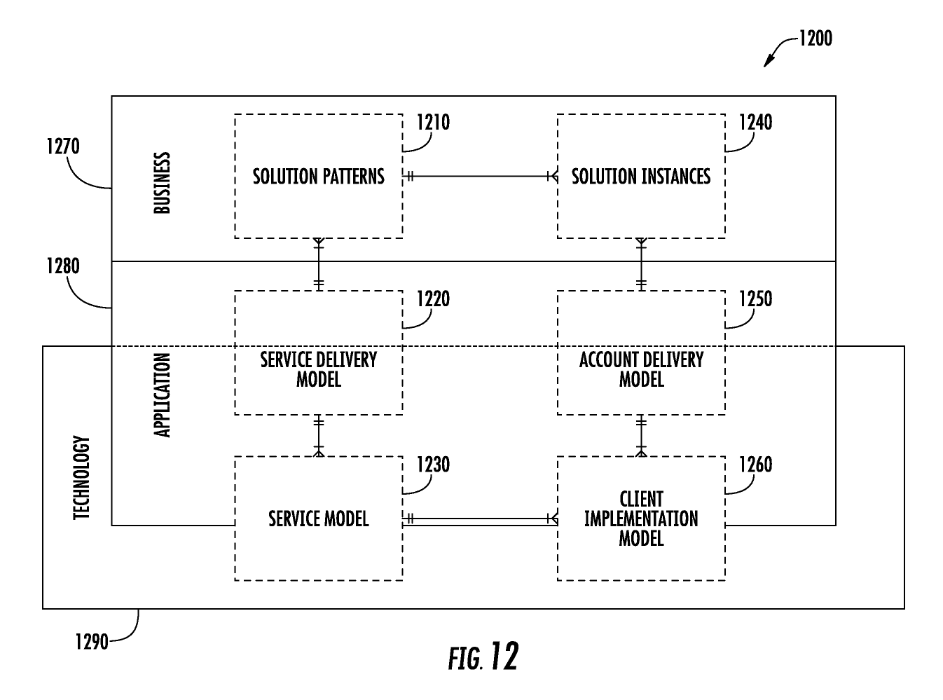

FIG. 12 is a diagram of the example of the architecture reference model for supporting business resource modeling shown in FIG. 9 showing business layer, application layer, and technology layer overlays. In particular, FIG. 12 illustrates an architecture reference model 1200 that includes solution patterns 1210, a service delivery model 1220, a service model 1230, solution instances 1240, an account delivery model 1250, and a client implementation model 1260. FIG. 12 also illustrates a business layer overlay 1270 that covers solution patterns 1210 and solution instances 1240. FIG. 12 further illustrates an application layer overlay 1280 that covers service delivery model 1220 and account delivery model 1250, and partially overlaps with service model 1230 and client implementation model 1260. FIG. 12 yet further illustrates a technology layer 1290 that covers service model 1230 and client implementation model 1260, and partially overlaps service delivery model 1220 and account delivery model 1250. Business layer 1270, application layer 1280, and technology layer 1290 may correspond to architecture specifications and/or standards such as, for example, Archimate. For example, business layer 1270 may have direct mapping to the business layer of the Archimate standard, while application layer 1280 and technology layer 1290 provide a progression from the application and technology layers with the Archimate standard.

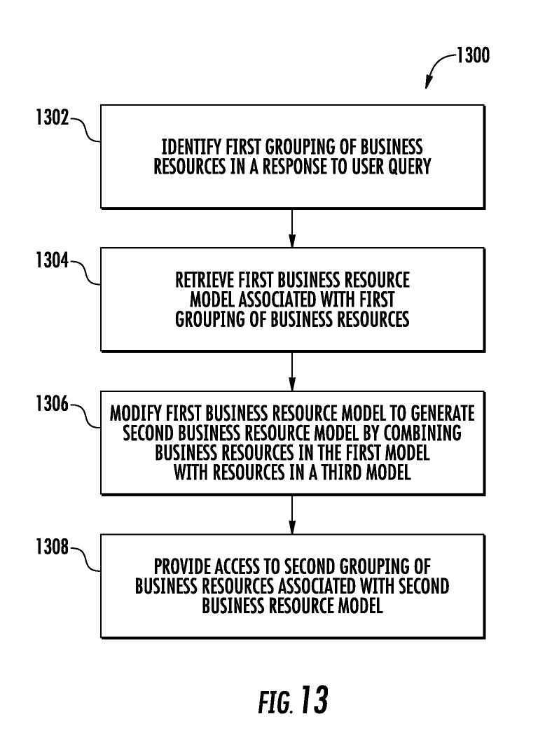

FIG. 13 is a flow diagram of another example method 1300 that may be carried out by the business resource modeling system of FIG. 1. As indicated by a step 1302, identification module 120 identifies a grouping of business resources in response to, for example a user query 160 from a user 162. User query 160 may be, for example, a keyword search facilitated by enterprise architecture management software that allows user 162 to identify relevant groupings of business resources based on indexing data 150 mapped to business resource models 110 associated with the groupings of business resources.

As indicated by a step 1304, model generation module 130 retrieves a business resource model 110 associated with an identified grouping of business resources. Business resource models 110 may be based upon, for example, Archimate and/or TOSCA standards. Business resource model 110 may define relationships among business resources in groupings of business resources and maintain traceability among reference architectures for groupings of business resource offerings among, for example, multiple client-specific implementations. Business resource model 110 may also reflect technical details of a grouping of business resources, such as relationships among objects such as business level components, service components, local applications, deployment models, installation instructions, foundation service, lifecycle models, physical components etc.

As indicated by a step 1306, model generation module 130 modifies business resource model 110 in order to generate a new business resource model in response to user input. In particular, model generation module 130 modifies the first existing business resource model 110 identified in step 1304 in order to generate a second, new business resource model 110 by combining business resources in the first business resource model 110 with business resources included in another existing third business resource model associated with another grouping of business resources from the groupings of business resources.

For example, as described above with reference to FIG. 2, user 172 may be a system architect who has received a request from a client principal to create a new business resource model 110 for a new grouping of business resources. The new grouping of business resources may be, for example, a version of a client's existing social media solution that may be used with a different social media application used in China. The client principal may have further identified an existing social medial integration application for China using identification module 120 (e.g., in step 1302). As such, user 172 may access business resource modeling system 100 and request model generation module 130 to make copies of the existing business resource model 110 for the client's social media solution, as well as the existing business resource model 110 for the social medial integration application for China. Model generation module 130 may then duplicate objects included in each of the existing business resource models 110 and use them as new objects in a new business resource model 110 to be associated with the new grouping of business resources for the client. Model generation module 130 maintains full traceability of the objects in the new business resource model 110 back to the original objects in the existing business resource models 110. The objects include relationships and attributes needed to deploy, manage, and modify the new grouping of business resources.

User 172 may then provide user input 170 requesting model generation module 130 to modify the new business resource model 110 in order to tailor it to the client's specific needs. For example, model generation module 130 may provide access to an architecture modeling and design tool that facilitates review and modification of the new business resource model 110 via graphical user interfaces. User 172 may import the new business resource model 110 into the architecture modeling and design tool and make any changes necessary to objects in the new business resource model 110, such as adding, changing, or deleting business layer objects, application layer objects, technical layer objects, etc. in order to meet the client's requirements. The new business resource model 110 includes any required objects from the original business resource models 110 as well as any new objects, such as services, components, lifecycle models, etc., needed in order to meet the client's requirements. In particular, the new business resource model 110 represents efficient reuse of two existing business resource models 110 to create a new version of the client's social media solution that may be used in China. User 170 may then request model generation module 130 to save the new business resource model 110 in memory 106. Model generation module may further provide for governance of model generation module 130, such as review, comment, approval, and release. As indicated by a step 1308, access module 140 provides access to a grouping of business resources associated with the second, new business resource model 110.

While the embodiments of the invention have been illustrated and described, it will be appreciated that various changes can be made therein without departing from the spirit and scope of the invention. For example, although different example embodiments may have been described as including one or more features providing one or more benefits, it is contemplated that the described features may be interchanged with one another or alternatively be combined with one another in the described example embodiments or in other alternative embodiments. One of skill in the art will understand that the invention may also be practiced without many of the details described above. Accordingly, it will be intended to include all such alternatives, modifications and variations set forth within the spirit and scope of the appended claims. Further, some well-known structures or functions may not be shown or described in detail because such structures or functions would be known to one skilled in the art. Unless a term is specifically and overtly defined in this specification, the terminology used in the present specification is intended to be interpreted in its broadest reasonable manner, even though may be used conjunction with the description of certain specific embodiments of the present invention.

What is claimed is:

1. A computer implemented method comprising:
receiving indexing data for groupings of business resources;
identifying a first grouping of business resources from the groupings of business resources in response to a user query based on the indexing data;
retrieving a first business resource model associated with the first grouping of business resources, wherein the first business resource model defines relationships among the business resources in the first grouping and further defines relationships among the groupings of business resources with respect to the first grouping of business resources;
generating a second business resource model based on the first business resource model in response to user input; and
providing access to a second grouping of business resources associated with the second business resource model.

2. The method of claim 1, wherein generating the second business resource model includes modifying the first business resource model.

3. The method of claim 2, wherein modifying the first business resource model includes combining business resources in the first business resource model with business resources included in a third business resource model associated with a third grouping of business resources from the groupings of business resources.

4. The method of claim 1, wherein the indexing data comprises one of partner data, activity data, resource data, value proposition data, customer relationship data, customer segment data, channel data, cost structure data, and revenue stream data.

5. The method of claim 1, wherein the business resources in the first grouping include one of software resources, physical resources, and human resources.

6. A system comprising:
a network interface;
a processor in communication with the network interface; and
a tangible non-transient computer readable medium including instructions for directing the processor to:
receive indexing data for groupings of business resources;
identify a first grouping of business resources from the groupings of business resources in response to a user query based on the indexing data;
retrieve a first business resource model associated with the first grouping of business resources, wherein the first business resource model defines relationships among the business resources in the first grouping and further defines relationships among the groupings of business resources with respect to the first grouping of business resources;
generate a second business resource model based on the first business resource model in response to user input; and
provide access to a second grouping of business resources associated with the second business resource model.

7. The system of claim 6, wherein the tangible non-transient computer readable medium further includes instructions for directing the processor to generate the second business resource model by modifying the first business resource model.

8. The system of claim 7, wherein the tangible non-transient computer readable medium further includes instructions for directing the processor to modify the first business resource model by combining business resources in the first business resource model with business resources included in a third business resource model associated with a third grouping of business resources from the groupings of business resources.

9. The system of claim 6, wherein the indexing data comprises one of partner data, activity data, resource data, value proposition data, customer relationship data, customer segment data, channel data, cost structure data, and revenue stream data.

10. The system of claim 6, wherein the business resources in the first grouping include one of software resources, physical resources, and human resources.

11. A computer implemented method comprising:
identifying a first grouping of business resources from groupings of business resources in response to a user query;
retrieving a first business resource model associated with the first grouping of business resources, wherein the first business resource model defines relationships among the business resources in the first grouping and further defines relationships among the groupings of business resources with respect to the first grouping;
modifying the first business resource model in order to generate a second business resource model in response to user input, wherein modifying the first business resource model includes combining business resources in the first business resource model with business resources included in a third business resource model associated with a third grouping of business resources from the groupings of business resources; and
providing access to a second grouping of business resources associated with the second business resource model.

12. The method of claim 11, further comprising receiving indexing data for the groupings of business resources.

13. The method of claim 12, wherein the first grouping of business resources is identified in response to the user query based on the indexing data.

14. The method of claim 12, wherein the indexing data comprises one of partner data, activity data, resource data, value proposition data, customer relationship data, customer segment data, channel data, cost structure data, and revenue stream data.

15. The method of claim 11, wherein the business resources in the first grouping include one of software resources, physical resources, and human resources.
